(19) United States
(12) Patent Application Publication
(10) Pub. No.: US 2026/0025201 A1
(43) Pub. Date: Jan. 22, 2026

(54) FILTER IMPLEMENTATION METHOD AND APPARATUS, NOISE SUPPRESSION METHOD AND APPARATUS, AND COMPUTER DEVICE

(71) Applicant: InnoLight Technology (Suzhou) Ltd., Suzhou, Jiangsu (CN)

(72) Inventor: Ning Cheng, Suzhou, Jiangsu (CN)

(21) Appl. No.: 18/993,046

(22) PCT Filed: Jun. 6, 2023
(86) PCT No.: PCT/CN2023/098490

§ 371 Date: Jan. 10, 2025

(30) Foreign Application Priority Data
Jul. 12, 2022 (CN) 202210814493.7

(51) Int. Cl. H04B 10/077; H04B 10/2507

(52) U.S. Cl. CPC H04B 10/0775; H04B 10/2507

(57) ABSTRACT

The present application relates to a filter implementation method and apparatus, a noise suppression method and apparatus, and a computer device, a storage medium and a computer program product. The filter implementation method comprises: acquiring a first signal frequency spectrum and a first power spectrum, which correspond to a first test signal; determining a noise spectrum of the first test signal according to the first signal frequency spectrum and the first power spectrum; then acquiring a second signal frequency spectrum corresponding to a second test signal; and determining a frequency response of a Wiener filter according to the second signal frequency spectrum and the noise spectrum of the first test signal. By means of the filter implementation method in combination with a frequency domain method, a frequency response of a Wiener filter under MPI noise can be obtained, such that an optimal filter for the MPI noise can be achieved, and the MPI noise can be suppressed to the greatest extent, thereby preventing the transmission of a PAM signal from being impacted by the MPI noise.

### CROSS-REFERENCE TO RELATED PATENT APPLICATION

The present disclosure claims the priority of the Chinese patent application submitted to the China Patent Office on Jul. 12, 2022, with the application No. 202210814493.7, and the invention name is “FILTER IMPLEMENTATION METHOD AND APPARATUS, NOISE SUPPRESSION METHOD AND APPARATUS, AND COMPUTER DEVICE”, all of which the contents are incorporated into the present disclosure by reference.

### FIELD OF THE DISCLOSURE

The present disclosure relates to the field of communication technology, and in particular to a filter implementation method, a noise suppression method, a device, a computer device, a storage medium and a computer program product.

### BACKGROUND TECHNIQUE

With advancements in communication technology, pulse amplitude modulation (PAM) has been widely adopted in optical interconnections. PAM signals can be generated through intensity modulation, allowing the receiving end to perform direct detection according to intensity modulation (Intensity Modulation-Direct Detection, IMDD). Compared to traditional Non-Return-to-Zero (NRZ) binary modulation signals, each symbol in a PAM signal carries more bits, enabling PAM modulation to achieve higher bit rate transmission under the same channel bandwidth.

However, in the actual transmission system, the optical transmitting end, the optical receiving end and the optical fiber connector will all cause reflection, and the optical signal will cause multi-path interference (MPI) effect when passing through multiple reflecting end faces during the transmission process. The MPI noise generated by the multipath interference effect can easily have adverse effects on the detection of transmitted signals. Especially under PAM modulation, MPI noise causes the bit error rate to increase significantly, thereby bringing a large optical power cost to the optical transmission system.

In traditional technology, according to the impact of MPI noise on PAM signal transmission, there are currently some methods to suppress MPI noise. For example, there are digital filtering and analog filtering solutions; however, experience has proven that these solutions are not optimal for addressing MPI. They cannot effectively filter out MPI noise under conditions of severe MPI noise or when the PAM transmission signal exhibits large chirps. Another example is the high-pass filtering method. Although this method can filter out low-frequency MPI noise, it is only effective for chirp-free PAM signals. For PAM signals generated by a Directly Modulated Laser (DML), the signal itself exhibits a large chirp, which causes the MPI noise spectrum to expand into higher frequencies, rendering simple high-pass filtering ineffective in reducing MPI noise. In addition, high-pass filtering at the receiving end results in DC drift (DC Wander), which adversely impacts the recovery of the PAM signal. To address these challenges and minimize the impact of MPI noise on the PAM transmission system, strict limits on the return loss (Return Loss) of connectors in optical modules and optical fiber links have been implemented. For instance, international standards such as IEEE802.3 (a network protocol) and 100G Lambda MSA (an optical interconnect system specification) have reduced the maximum allowable return loss for optical fiber connectors from the original −26 dB to −35 dB. However, in practical optical fiber links that have been deployed, the presence of multiple connectors and the difficulty of controlling the return loss of connectors below −35 dB mean that MPI noise in real-world systems can impose significant optical power costs on PAM transmission. In some actual links, even when complex forward error correction codes (Forward Error Correction, FEC) are applied, error-free PAM signal transmission still cannot be achieved. Therefore, minimizing the impact of MPI noise on PAM signal transmission is an urgent problem that must be resolved.

### SUMMARY OF THE DISCLOSURE

According to this, it is necessary to address the above technical problems and provide a filter implementation method, noise suppression method, device, computer equipment, storage medium and computer program product that can effectively suppress the impact of MPI noise on PAM signal transmission.

In a first aspect, the present disclosure provides a method for implementing a Wiener filter, and the method includes:
acquiring a first signal spectrum and a first power spectrum corresponding to the first test signal, wherein the first test signal is an optical signal after a signal transmitting end modulates first test data and transmits the first test data through an optical fiber;
determining a noise spectrum of the first test signal according to the first signal spectrum and the first power spectrum;
acquiring a second signal spectrum corresponding to the second test signal, wherein the second test signal is an optical signal after a signal transmitting end modulates second test data and transmits the second test data through an optical fiber, and a period of the second test data is greater than a period of the first test data; and
determining a frequency response of the Wiener filter according to the second signal spectrum and the noise spectrum of the first test signal.

In one embodiment, determining the frequency response of the Wiener filter according to the second signal spectrum and the noise spectrum of the first test signal includes: acquiring a first difference between the second signal spectrum and the noise spectrum of the first test signal; acquiring a sum between the first difference and the noise spectrum of the first test signal; and determining a frequency response of the Wiener filter according to the first difference and the sum.

In one embodiment, determining the frequency response of the Wiener filter according to the first difference and the sum includes: determining a ratio of the first difference to the sum as the frequency response of the Wiener filter.

In one embodiment, determining the noise spectrum of the first test signal according to the first signal spectrum and the first power spectrum includes: acquiring a second difference between the first signal spectrum and the first power spectrum, and using the second difference as the noise spectrum of the first test signal.

In one embodiment, after determining the noise spectrum of the first test signal, the method further includes: acquiring a received noise spectrum, which is utilized to characterize a noise of a signal receiving end itself; and determining a multipath interference noise spectrum according to the noise spectrum of the first test signal and the received noise spectrum.

In one embodiment, acquiring the received noise spectrum includes: acquiring a second power spectrum corresponding to a detection signal, wherein the second power spectrum is utilized as the received noise spectrum, and the detection signal is a noise generated by the signal receiving end when no optical signal is input.

In one embodiment, determining the multipath interference noise spectrum according to the noise spectrum of the first test signal and the received noise spectrum includes: acquiring a third difference between the noise spectrum of the first test signal and the received noise spectrum, wherein the third difference is utilized as the multipath interference noise spectrum.

In a second aspect, the present disclosure provides a method for suppressing multipath interference noise, characterized in that the method is applied to a signal receiving end of an optical communication system, and the method includes: acquiring a received signal; filtering the received signal according to the frequency response of the Wiener filter to acquire a filtered target signal; and implementing the frequency response of the Wiener filter according to the method of the first aspect.

In one embodiment, the frequency response of a Wiener filter is utilized to filter the received signal to acquire the filtered target signal, including: performing spectral decomposition on the frequency response of the Wiener filter to acquire the frequency response of a causal Wiener filter; and filtering the received signal according to the frequency response of the causal Wiener filter to acquire the filtered target signal.

In a third aspect, the present disclosure provides a device for implementing a Wiener filter, characterized in that the device includes: a first spectrum acquisition module, configured to acquire a first signal spectrum and a first power spectrum corresponding to the first test signal, wherein the first test signal is an optical signal after the signal transmitting end modulates first test data and transmits the first test data through the optical fiber; a noise spectrum determination module, configured to determine a noise spectrum of the first test signal according to the first signal spectrum and the first power spectrum; a second spectrum acquisition module, configured to acquire a second signal spectrum corresponding to the second test signal, wherein the second test signal is an optical signal after a signal transmitting end modulates second test data and transmits the second test data through an optical fiber, and a period of the second test data is greater than a period of the first test data; and a filter determination module, configured to determine a frequency response of the Wiener filter according to the second signal spectrum and the noise spectrum of the first test signal.

In a fourth aspect, the present disclosure provides a device for suppressing multipath interference noise, characterized in that the device is applied to a receiving end of an optical communications system, and the device includes: a received signal acquisition module, configured to acquire a received signal; and a filtering module, configured to filter the received signal according to the frequency response of the Wiener filter to acquire a filtered target signal; wherein the frequency response of the Wiener filter is implemented according to the method of any one of claims 1-7.

In a fifth aspect, the present disclosure provides an optical communication system, characterized in that the system includes: a signal transmitting end, configured to modulate an input transmission data to generate an optical signal; an optical fiber, configured to transmit the optical signal generated by the signal transmitting end; and a signal receiving end, configured to receive the optical signal transmitted by the optical fiber, and filter the optical signal using the frequency response of the Wiener filter implemented by the method of the first aspect to acquire a filtered target signal.

In a sixth aspect, the present disclosure provides a computer device, including a memory and a processor, wherein the memory stores a computer program, and is characterized in that the steps of the method of any one of the first and second aspects are implemented when the processor executes the computer program.

In a seventh aspect, the present disclosure provides a computer-readable storage medium on which a computer program is stored, characterized in that the steps of the method of any one of the first and second aspects are implemented when the computer program is executed by a processor.

In an eighth aspect, the present disclosure provides a computer program product, including a computer program, characterized in that the computer program implements the steps of the method of any one of the first and second aspects when executed by a processor.

The above-mentioned filter implementation method, noise suppression method, device, computer equipment, storage medium, and computer program product work by acquiring the first signal spectrum and the first power spectrum corresponding to the first test signal, and determining the noise spectrum of the first test signal according to the first signal spectrum and the first power spectrum. Subsequently, the second signal spectrum corresponding to the second test signal is acquired, and the frequency response of the Wiener filter is determined according to the second signal spectrum and the noise spectrum of the first test signal. By combining the frequency domain method, the frequency response of the Wiener filter under MPI noise can be acquired, thereby enabling the implementation of an optimal filter for MPI noise. This approach maximizes the suppression of MPI noise, effectively mitigating the adverse impact on PAM signal transmission.

### BRIEF DESCRIPTION OF THE DRAWINGS

FIG. 1 is a schematic flow chart of a method for implementing a Wiener filter in an embodiment;

FIG. 2A is a schematic diagram of the signal spectrum received by the receiving end of MPI at −36 dB in one embodiment;

FIG. 2B is a schematic diagram of the signal spectrum received by the receiving end of MPI at −33 dB in one embodiment;

FIG. 2C is a schematic diagram of the signal spectrum received by the receiving end of MPI at −30 dB in one embodiment;

FIG. 3 is a schematic flowchart of the steps of determining the frequency response of the Wiener filter in one embodiment;

FIG. 4 is a schematic flowchart of the steps of determining the multipath interference noise spectrum in one embodiment;

FIG. 5 is a schematic flow chart of a method for implementing a Wiener filter in another embodiment;

FIG. 6 is a schematic flow chart of a method for suppressing multipath interference noise in an embodiment;

FIG. 7 is a structural block diagram of an optical communication system in one embodiment;

FIG. 8 is a schematic diagram of the working principle of the optical communication system in one embodiment;

FIG. 9 is a structural block diagram of a device for implementing a Wiener filter in an embodiment;

FIG. 10 is a structural block diagram of a device for suppressing multipath interference noise in one embodiment;

FIG. 11 is an internal structure diagram of a computer device in one embodiment.

### DETAILED DESCRIPTION OF THE EXEMPLARY EMBODIMENTS

In order to make the purpose, technical solutions and advantages of the present disclosure more clear, the present disclosure will be further described in detail below with reference to the drawings and embodiments. It should be understood that the specific embodiments described here are only used to explain the present disclosure and are not used to limit the present disclosure.

Currently, how to minimize the interference of MPI noise on signals in optical fiber communication systems and separate useful signals is an urgent problem faced by receivers. The purpose of signal processing is to reduce the interference of MPI noise and restore the uninterrupted signal as much as possible. This is also a classic problem in the field of signal processing, usually called the optimal filter problem. For MPI noise, digital filtering and analog filtering solutions have been verified to a certain extent. However, under large MPI noise or when the PAM transmission signal has large chirp, MPI noise cannot be effectively filtered, and these solutions are not optimal filtering for MPI. Although the high-pass filtering method can filter out low-frequency MPI noise, it is only effective for chirp-free PAM signals. For PAM signals generated by directly modulated lasers, due to the large chirp in the signal itself, it will cause the MPI noise spectrum extends to high frequencies, so simple high-pass filtering is basically ineffective in reducing MPI noise. In addition, the high-pass filtering of the PAM signal at the receiving end will also produce DC drift, which will adversely affect the recovery of the PAM signal.

Although Wiener Filter can achieve optimal filtering with minimum mean square error, how to implement Wiener filter for MPI noise in optical fiber communication is a very challenging problem. Generally speaking, there are two ways to implement Wiener filters: time domain method and frequency domain method.

The time domain method can be realized by solving the Wiener-Hopf Equation: Rₓₓw=R_{xd}. The weight coefficient w of the digital Wiener filter can be acquired through this equation, but there are certain difficulties in how to determine the autocorrelation matrix Rₓₓ of the received signal x and the cross-correlation vector R_{xd} of the transmitted signal d and the received signal x. Although the autocorrelation matrix Rex can be acquired from the autocorrelation function and the cross-correlation vector R_{xd} can be acquired from the cross-correlation function, both the autocorrelation function and the mutual function are statistical quantities and require a large number of sample functions or statistical distribution of signals can be acquired. In optical communication systems, it is difficult for the signal receiving end to estimate the autocorrelation function of the received signal and the cross-correlation function of the transmitted signal and the received signal in real time. Even if the autocorrelation function and mutual function can be estimated from the sample function by taking advantage of the wide stationarity and ergodicity of the transmitted signal and the received signal, it still requires as many sample function sampling values as possible and a large amount of calculations, which is difficult in real-time high-rate light processing. It is unrealistic in communication.

As for the frequency domain method, the frequency response of the Wiener filter is generally determined by the power spectrum Sₓₓ (e^{jω}) of the received signal and the MPI noise spectrum S_{MPI} (e^{jω}). However, if the receiving end's own noise Sₘ (e^{jω}) cannot be ignored, the sum of the MPI noise spectrum S_{MPI} (e^{jω}) and the receiving end noise spectrum Sₘ (e^{jω}) should be referred to, which is the total noise spectrum S_{NN} (e^{jω}) determines the frequency response of the filter. S_{NN} (e^{jω})=S_{MPI} (e^{jω})+Sₘ (e^{jω}), then the frequency response of the Wiener filter is

$${H}_{opt} ( {e}^{j ω} ) = \frac{{S}_{xx} ( {e}^{j ω} )}{{S}_{xx} ( {e}^{j ω} ) + {S}_{NN} ( {e}^{j ω} )}$$

During the signal transmission process, due to the existence of MPI noise and the noise of the receiving end itself, the signal spectrum S_{Rx} (e^{jω}) measured by the receiving end actually includes the power spectrum Sxr (e^{jω}) of the received signal, the MPI noise spectrum S_{MPI} (e^{jω}) and the receiving end's own noise spectrum Su (e^{jω}). That is, S_{Rx} (e^{jω})=Sₓₓ (e^{jω})+S_{NN} (e^{jω}). The power spectrum Sₓₓ (e^{jω}) of the received signal is the energy spectrum after removing noise from the signal spectrum S_{Rx} (e^{jω}), that is, Sₓₓ (e^{jω})=S_{Rx} (e^{jω})−S_{NN} (e^{jω}). Specifically, the power spectrum Sₓₓ (e^{jω}) can be acquired by using the power spectrum estimation method, or, for commonly used signals such as NRZ and PAM4, it can also be acquired by using the analytical expression of the corresponding power spectrum. However, for the MPI noise spectrum S_{MPI} (e^{jω})), the corresponding expression is usually:

$${S}_{MPI} ( f ) = \frac{4 {R}^{2}}{π} \frac{Δ v}{{f}^{2} + {( Δ v )}^{2}}$$

Here, f is the frequency, Δv is the linewidth of the laser, and R is the equivalent MPI caused by multiple reflections in the fiber. The MPI noise spectrum given by the above formula is for the MPI noise spectrum generated by a continuous wave laser with a line width of Av in an optical fiber link. In an actual optical fiber communication system, due to large signal modulation, the transmitter modulator chirp caused will cause the MPI noise spectrum to no longer satisfy the above expression. There is currently no analytical expression for the MPI noise spectrum of the chirped signal, and since the MPI noise spectrum and the spectrum of the modulated signal are mixed together at the receiving end, it is currently impossible to acquire actual measurement results of the MPI noise spectrum of the chirped signal. Therefore, how to acquire the MPI noise spectrum of the chirp signal and use the frequency domain method to acquire the frequency response of the Wiener filter under MPI noise is the key.

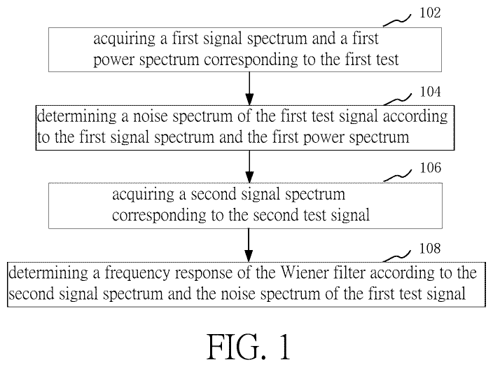

According to this, in one embodiment, as shown in FIG. 1, a method for implementing a Wiener filter is provided. The application of this method to an optical communication system is utilized as an example to illustrate. Specifically, it may include the following steps:

Step 102: acquiring a first signal spectrum and a first power spectrum corresponding to the first test signal.

The first test signal is an optical signal in which the signal transmitting end modulates the first test data and transmits the first test data through the optical fiber. Specifically, the first test data includes any one of periodic binary pseudo-random bit sequences (Pesuedorandom Bit Sequence, PRBS for short), square waves, sawtooth waves, triangle waves, or other periodic signals.

The first signal spectrum corresponding to the first test signal is the signal spectrum acquired by sampling the received first test signal and estimating the power spectrum at the signal receiving end, that is, S_{Rx} (e^{jω}). It can be understood that the signal spectrum includes the noise spectrum generated during the transmission of the first test signal, that is, S_{NN} (e^{jω}).

The first power spectrum is an energy spectrum without noise acquired according to the first test signal. Since the first test data is periodic data, the corresponding signal spectrum acquired by the receiving end only has signal energy at some discrete frequency points. For example, taking the optical communication system as a 25Gbaud PAM4 transmission system and the first test data as a PRBS7 binary code stream, its period is 2⁷-1 bits, and the PAM4 signal spectrum is only N×393.7 MHz (N is an integer, N=0,1,2,3 . . . ), so there is energy only at the frequency point. The corresponding energy spectrum lines at these frequency points are the first power spectrum corresponding to the first test signal, that is, Sₓₓ (e^{jω}). Specifically, the first power spectrum can be acquired by using a power spectrum estimation method according to the received first test signal, or, for NRZ, PAM4 and other signals, it can also be calculated by using the analytical expression of the corresponding power spectrum.

In this embodiment, before the data is officially transmitted, such as during power-on of the optical communication system, the signal transmitting end can form a first test signal by performing pulse amplitude modulation on the first test data, and transmit the first test signal to the optical fiber. In the optical communication system, the first signal spectrum and the first power spectrum corresponding to the first test signal received by the signal receiving end from the optical fiber are acquired.

Step 104: determining a noise spectrum of the first test signal according to the first signal spectrum and the first power spectrum.

Since the first power spectrum is an energy spectrum without noise estimated according to the first test signal, and the first signal spectrum includes the noise spectrum generated during the transmission of the first test signal, therefore, according to the first signal spectrum and the first power Spectrum, the noise spectrum of the first test signal can be determined.

In one scenario, considering that the chirp generated by the optical modulator at the transmitting end is related to the specific signal stream, and because MPI noise is related to the time domain waveform and chirp of the signal, the PRBS (pseudo-random binary code) code stream is closer to the code stream of the actual transmitted data, so the PRBS code stream with a shorter period can be used as the first test data. For example, code streams such as PRBS7, PRBS9 or PRBS11 are used as the first test data. This makes the noise spectrum acquired according to the first test signal modulated by the first test data closer to the actual noise spectrum.

Specifically, taking the optical communication system as a 25Gbaud PAM4 transmission system and the first test data as a PRBS7 binary code stream as an example, since the first test data is periodic data, its period is 2⁷-1 bits. Therefore, the spectrum corresponding to the PAM4 signal acquired by the receiving end only has energy at the frequency point of N×393.7 MHz (N is an integer, N=0,1,2,3 . . . ), while for MPI noise, its energy is in the entire spectrum. The range is continuously distributed.

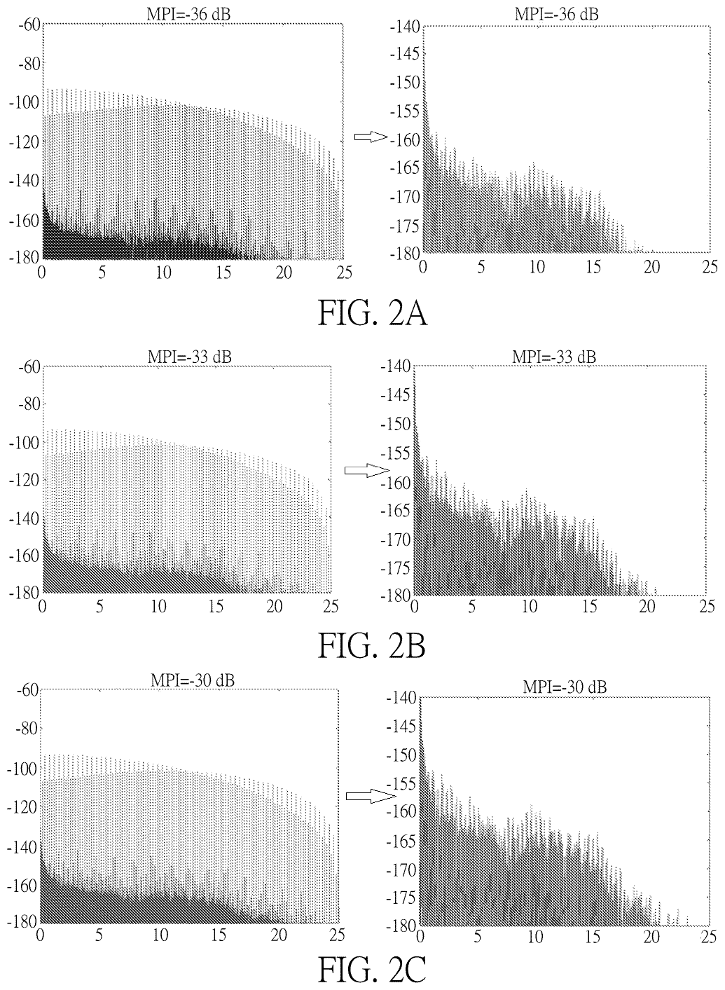

As shown in FIG. 2A, FIG. 2B and FIG. 2C, in the 25GPAM4 optical communication system with transmission code stream PRBS7, the signal spectrum received by the receiving end under different MPI (respectively at −36 dB, −33 dB and −30 dB) (as shown in the left picture of FIG. 2A, FIG. 2B and FIG. 2C) is given, where the horizontal axis represents frequency, and the vertical axis represents energy. As can be seen from the figures, the spectrum contains some discrete spectral lines, and these discrete spectral lines are exactly the power spectrum of the PAM4 signal (that is, the received signal according to the PRBS7 code stream). In addition to these discrete spectral lines, the spectrum also contains a continuous spectrum with relatively low energy, which is the MPI noise spectrum and the receiving end noise spectrum. Therefore, if the discrete signal spectral lines in the signal spectra on the left of FIG. 2A, FIG. 2B and FIG. 2C are removed, the noise spectrum of the received signal (the noise Spectrum includes MPI noise spectrum and receiving end noise spectrum) as shown in FIG. 2A, FIG. 2B and FIG. 2C on the right can be obtained. Since discrete signal spectral lines are removed from the spectrum, the noise spectrum acquired in this way has no measurement value at these discrete frequency points. In order to make up for the missing noise spectrum on these discrete spectrum lines, you can repeat the above steps according to another PRBS code stream with different periods to measure the missing noise spectrum on those discrete frequency points.

Specifically, in this embodiment, according to the first signal spectrum and the first power spectrum corresponding to the first test signal acquired above, and removing the discrete first power spectrum from the first signal spectrum, the noise spectrum of the first test signal can be acquired. For example, the difference between the first signal spectrum and the first power spectrum can be calculated, and then the difference can be used as the noise spectrum of the first test signal.

Step 106: acquiring a second signal spectrum corresponding to the second test signal.

The second test signal is an optical signal in which the signal transmitting end modulates the second test data and transmits the second test data through the optical fiber. Specifically, the period of the second test data is greater than the period of the first test data. For example, the first test data can use a code stream such as PRBS7, PRBS9 or PRBS11 with a shorter period, and the second test data can use a code stream such as PRBS31 with a longer period. In this embodiment, the data to be transmitted can be simulated through the second test data, and the second test data is modulated by the signal transmitting end. After the second test signal is acquired, it is transmitted through the optical fiber, and the optical communication system acquires the signal. The receiving end samples the second test signal from the optical fiber, and acquires the second signal spectrum corresponding to the sampled second test signal through power spectrum estimation. It can be understood that the meanings of the second signal spectrum and the first signal spectrum are similar, and the difference is that they are signal spectrums corresponding to different received signals. In this embodiment, in order to distinguish the signal spectrum of different received signals, the signal spectrum corresponding to the received first test signal is defined as the first signal spectrum, and the signal spectrum corresponding to the received second test signal is defined as the second signal spectrum.

Step 108: determining a frequency response of the Wiener filter according to the second signal spectrum and the noise spectrum of the first test signal.

In this embodiment, the optical communication system can determine the frequency response of the Wiener filter according to the frequency domain method of the Wiener filter and according to the second signal spectrum acquired above and the noise spectrum of the first test signal. And since the filter is mainly characterized by frequency response, once the frequency response of the Wiener filter is determined, the corresponding Wiener filter is also determined.

In the implementation method of the above Wiener filter, the optical communication system acquires the first signal spectrum and the first power spectrum corresponding to the first test signal, and determines the noise spectrum of the first test signal according to the first signal spectrum and the first power spectrum, and then acquires the second signal spectrum corresponding to the second test signal, and determines the frequency response of the Wiener filter according to the second signal spectrum and the noise spectrum of the first test signal. By combining the frequency domain method, the frequency response of the Wiener filter under MPI noise can be acquired, so that the optimal filter for MPI noise can be realized and the MPI noise can be suppressed to the maximum extent to avoid the impact of MPI noise on PAM signal transmission. Influence.

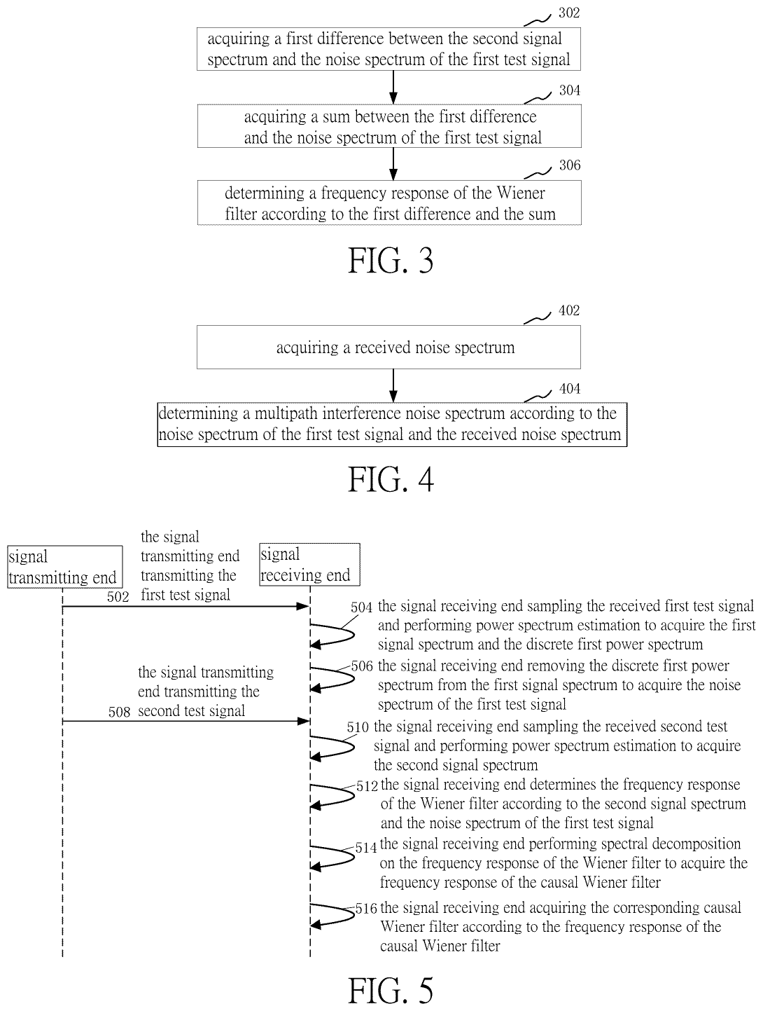

In one embodiment, as shown in FIG. 3, determining the frequency response of the Wiener filter according to the second signal spectrum and the noise spectrum of the first test signal may also include:

Step 302: acquiring a first difference between the second signal spectrum and the noise spectrum of the first test signal.

The second signal spectrum simulates the data to be transmitted through the second test data, and the second test data is modulated by the signal transmitting end. After the second test signal is acquired, it is transmitted through the optical fiber, and is acquired from the optical fiber through the signal receiving end. The second test signal is sampled, and the signal spectrum corresponding to the sampled second test signal is estimated through the power spectrum. Since the signal spectrum includes both the power spectrum of the second test signal and the corresponding noise spectrum, and the noise spectrum of the first test signal can be approximated to the actual noise spectrum, the power spectrum of the second test signal can therefore be acquired by calculating the difference between the second signal spectrum and the noise spectrum of the first test signal.

Specifically, the optical communication system acquires the first difference between the second signal spectrum and the noise spectrum of the first test signal. The first difference is the power spectrum of the second test signal, that is, from the second signal spectrum Energy spectrum after removing noise.

Step 304: acquiring a sum between the first difference and the noise spectrum of the first test signal.

Step 306: determining a frequency response of the Wiener filter according to the first difference and the sum.

Specifically, according to the frequency response expression of the above-mentioned Wiener filter, the optical communication system determines the above-mentioned ratio of the first difference to the sum as the frequency response of the Wiener filter.

Specifically, if the first signal spectrum corresponding to the first test signal is S1_{Rx} (e^{jω}) and the first power spectrum corresponding to the first test signal is S1ₓₓ (e^{jω}), the noise spectrum S_{NN} (e^{jω}) of the first test signal can be acquired by subtracting the first power spectrum S1ₓₓ (e^{jω}) from the first signal spectrum S1_{Rx} (e^{jω}), as expressed by the formula: S_{NN} (e^{jω})=S1_{Rx} (e^{jω})−S1ₓₓ (e^{jω}). That is, the noise spectrum S_{NN} (e^{jω}) of the first test signal represents the difference between the first signal spectrum Sₓₓ (e^{jω}) and the first power spectrum S1_{Rx} (e^{jω}). Since the noise spectrum of the first test signal can approximate the actual noise spectrum, it can be used as the noise spectrum for any signal received by the receiving end.

According to this, if the second signal spectrum corresponding to the second test signal is S2_{Rx} (e^{jω}), then the energy spectrum after removing the noise from the second signal spectrum S2_{Rx} (e^{jω}) is S2ₓₓ (e^{jω}), that is, S2ₓₓ (e^{jω})=S2_{Rx} (e^{jω})−S_{NN} (e^{jω}), according to the above expression, the frequency response of the Wiener filter can be acquired as:

$${H}_{opt} ( {e}^{j ω} ) = \frac{S {2}_{xx} ( {e}^{j ω} )}{S {2}_{xx} ( {e}^{j ω} ) + {S}_{NN} ( {e}^{j ω} )}$$

Here, the numerator is the first difference between the second signal spectrum S2_{Rx} (e^{jω}) and the noise spectrum Sₓₓ (e^{jω}) of the first test signal, that is, the energy spectrum S2ₓₓ (e^{jω}) after removing the noise spectrum S_{NN} (e^{jω}) from the second signal spectrum S2_{Rx} (e^{jω}). The denominator is the sum between the first difference value S2ₓₓ (e^{jω}) and the noise spectrum S_{NN} (e^{jω}), that is, the denominator is S2 xx (e^{jω})+S_{NN} (e^{jω}).

In the above embodiment, the optical communication system determines the noise spectrum of the signal according to the first signal spectrum and the first power spectrum corresponding to the first test signal, and determines the dimension according to the noise spectrum and the second signal spectrum corresponding to the second test signal. The frequency response of the Wiener filter is improved, thereby improving the accuracy of the frequency response of the Wiener filter.

In one scenario, the above-mentioned Wiener filter implementation method can be implemented at the signal receiving end in the actual link, so this method has adaptive characteristics. Although there are currently a large number of adaptive filter implementation methods, such as least mean square (LMS) adaptive filtering and recursive least squares (RLS) adaptive filtering, these methods are in the sense of statistical averages. It is close to the Wiener filter, but due to the estimation error, the performance of these adaptive filters cannot reach the performance of the Wiener filter. And since adaptive filters all have convergence problems, if the adaptive step size is not selected appropriately, it will also lead to problems of no convergence or too slow convergence. In contrast, the Wiener filter implemented in this disclosure is the optimal filter for MPI noise and has good stability. There will be no convergence issues.

In one embodiment, as shown in FIG. 4, after determining the noise spectrum of the first test signal, the above method may further include:

Step 402: acquiring a received noise spectrum.

The received noise spectrum is utilized to characterize the noise at the signal receiving end itself. Since the noise spectrum of the first test signal includes both the noise of the receiving end itself and the MPI noise of the signal transmitted in the optical fiber, if the noise of the receiving end itself can be determined, the MPI noise can also be determined.

And since MPI noise is the noise generated when signals are transmitted in optical fibers, when there is no optical signal transmission in the optical fiber, there is no MPI noise and no useful signal. According to this, the optical communication system determines the noise of the receiving end itself by detecting the second power spectrum of the detection signal detected by the signal receiving end when there is no optical signal. Since there is no signal transmission in the optical fiber at this time, that is, there is neither MPI noise nor useful signal in the detection signal. Therefore, the second power spectrum of the detection signal is the noise of the receiving end itself, that is, the received noise spectrum. Specifically, in this embodiment, the second power spectrum corresponding to the detection signal can be used as the received noise spectrum of the receiving end itself.

Step 404: determining a multipath interference noise spectrum according to the noise spectrum of the first test signal and the received noise spectrum.

Specifically, the optical communication system acquires the third difference between the noise spectrum of the first test signal and the received noise spectrum, and uses the third difference as the multipath interference noise spectrum. For example, if the received noise spectrum is Sₘ (e^{jω}) and the noise spectrum of the first test signal is S_{NN} (e^{jω}), then the corresponding multipath interference noise spectrum S_{MPI} (e^{jω})=S_{NN} (e^{jω})−Sₘ (e^{jω}). That is, the multipath interference noise spectrum is the difference between the noise spectrum of the first test signal and the received noise spectrum. For the convenience of explanation, to distinguish different differences, the difference is defined as the third difference.

In the above embodiment, the optical communication system determines the multipath interference noise spectrum by acquiring the received noise spectrum and according to the noise spectrum of the first test signal and the received noise spectrum, that is, determining the multipath interference noise spectrum as the difference between the noise spectrum of the first test signal and the received noise spectrum can achieve accurate measurement of the MPI noise spectrum.

In one embodiment, as shown in FIG. 5, the implementation method of the above-mentioned Wiener filter is further described below, taking the application of this method to an optical communication system as an example, where the optical communication system includes a signal transmitting end and a signal receiving end, then the method may specifically include the following steps:

Step 502: the signal transmitting end transmitting the first test signal.

The first test signal is acquired by performing pulse amplitude modulation on the first test data before the signal transmitting end transmits the actual signal, such as during power-on of the optical module.

Step 504: the signal receiving end sampling the received first test signal and performing power spectrum estimation to acquire the first signal spectrum and the discrete first power spectrum.

Here, the frequency of the first power spectrum S_{PRBS} (e^{jω}) can be determined by the baud rate of the first test signal, the number of bits of the symbol and the sequence length of the period. And since the power spectrum is a function of frequency, the corresponding power spectrum can be acquired after determining the frequency.

Specifically, in this embodiment, the frequency of the first power spectrum can be determined by the following formula:

$${f}_{n} = N * baud rate * m / PRBS code N = 0 , 1 , 2 , 3 …$$

Here, m is the number of bits of the symbol, m=log 2 M. M is the size of the sent symbol set. For PAM4 signals, M=4, m=2. N is the harmonic number. f_{N} represents the frequency corresponding to the N^{th} harmonic of the periodic first test signal. The PRBS code length is the sequence length of the corresponding period. For example, the PRBS code length can be 2⁷-1 (i.e. 127), 2⁹-1 (i.e. 511), 2¹¹-1 (i.e. 2047), etc. Since the PRBS signal is a periodic signal, the PRBS signal only has energy at the f_{N} frequency point, while the signal energy at other frequency points is zero.

The first signal spectrum S_{RxPRBS} (e^{jω}) is a signal spectrum acquired by sampling the received first test signal and performing power spectrum estimation. The signal spectrum includes the noise spectrum S_{NN} (e^{jω}) generated during the transmission of the first test signal. That is, S_{RxPRBS} (e^{jω})=S_{PRBS} (e^{jω})+S_{NN} (e^{jω}).

Step 506: the signal receiving end removing the discrete first power spectrum from the first signal spectrum to acquire the noise spectrum of the first test signal.

Specifically, the noise spectrum S_{NN} (e^{jω}) of the first test signal=S_{RxPRBS} (e^{jω})−S_{PRBS} (e^{jω}).

Step 508: the signal transmitting end transmitting the second test signal.

The second test signal is an optical signal after the signal transmitting end modulates the second test data and transmits it through the optical fiber. Specifically, the period of the second test data is greater than the period of the first test data.

Step 510: the signal receiving end sampling the received second test signal and performing power spectrum estimation to acquire the second signal spectrum.

The second signal spectrum S_{Rx} (e^{jω}) is a signal spectrum acquired by sampling the received second test signal and performing power spectrum estimation. The signal spectrum includes the noise spectrum S_{NN} (e^{jω}) generated during the transmission of the second test signal and the spectrum of the actual signal.

Step 512: the signal receiving end determines the frequency response of the Wiener filter according to the second signal spectrum and the noise spectrum of the first test signal.

Since the noise spectrum S_{NN} (e^{jω}) of the first test signal has been determined by the aforementioned method, the real spectrum of the second test signal can be determined, that is, the spectrum after removing the noise Sₓₓ (e^{jω})=S_{Rx} (e^{jω})−S_{NN} (e^{jω}).

Then the frequency response of the Wiener filter is:

$${H}_{opt} ( {e}^{j ω} ) = \frac{{S}_{xx} ( {e}^{j ω} )}{{S}_{xx} ( {e}^{j ω} ) + {S}_{NN} ( {e}^{j ω} )}$$

Step 514: the signal receiving end performing spectral decomposition on the frequency response of the Wiener filter to acquire the frequency response of the causal Wiener filter.

The signal receiving end performs spectral decomposition on the frequency response Hₒₚₜ (e^{jω}) of the Wiener filter to acquire the frequency response H_{wiener} (e^{jω}) of the causal Wiener filter.

Step 516: the signal receiving end acquiring the corresponding causal Wiener filter according to the frequency response of the causal Wiener filter.

Since a filter is mainly characterized by its frequency response, when the frequency response of a causal Wiener filter is known, the corresponding causal Wiener filter is also determined.

In this embodiment, the power spectrum and noise spectrum of the received signal can be estimated through the signal receiving end, and then the frequency domain method is utilized to acquire the frequency response of the Wiener filter, and the causal Wiener filter is finally derived using the spectral decomposition method, so that the optimal filter under the minimum mean square error can be realized for the MPI noise in the link. It is not only simple to implement, has good stability, but also has adaptive characteristics for different MPI noises.

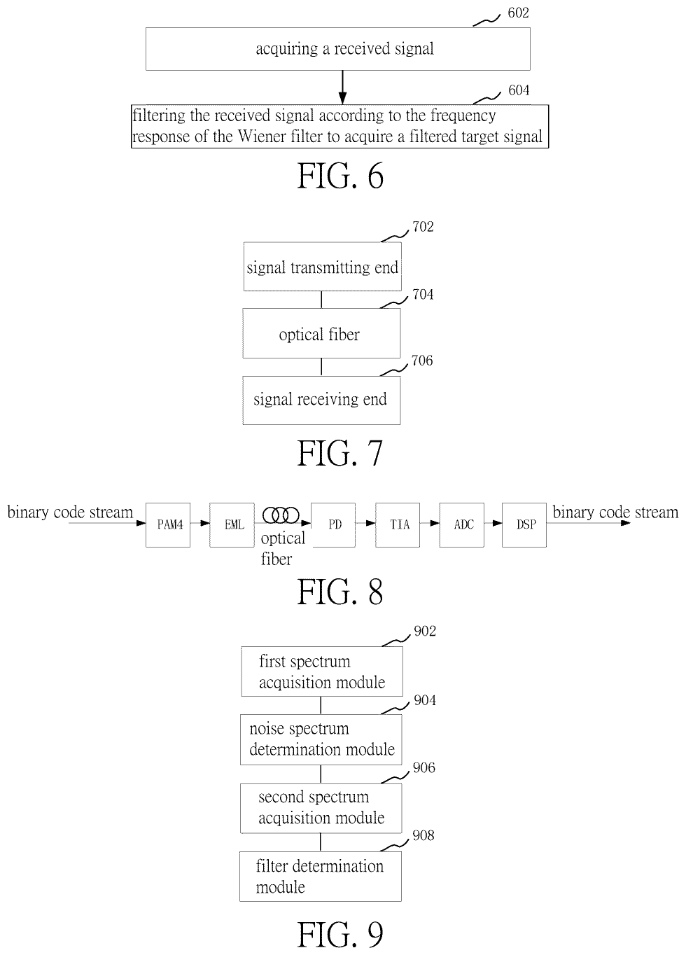

In one embodiment, as shown in FIG. 6, the present disclosure also provides a method for suppressing multipath interference noise. This embodiment uses the application of this method to the signal receiving end of an optical communication system as an example to illustrate. Specifically, it may include Follow these steps:

Step 602: acquiring a received signal.

The received signal is an optical signal that is received by the signal receiving end after the signal transmitting end performs pulse amplitude modulation on the transmitted data and transmits it through the optical fiber.

Step 604: filtering the received signal according to the frequency response of the Wiener filter to acquire a filtered target signal.

Here, the frequency response of the Wiener filter is realized according to the method described in FIGS. 1 to 5. In this embodiment, the signal receiving end uses the frequency response of the Wiener filter implemented by the above method to filter the received signal, thereby acquiring the target signal after filtering the noise, so as to achieve error-free PAM signal transmission.

In one embodiment, since the frequency response of the Wiener filter acquired through the frequency domain method is usually a non-causal filter, it cannot be implemented in a real-time receiver. Therefore, in this embodiment, when the optical communication system is a real-time communication system, that is, when the signal receiving end is a real-time receiving end, the frequency response of the Wiener filter is utilized to filter the received signal to acquire the filtered target signal, Specifically, it may include: performing spectral decomposition on the frequency response of the Wiener filter to acquire the frequency response of the causal Wiener filter, and then filtering the received signal according to the frequency response of the causal Wiener filter to acquire the filtered target signal. In this way, the optimal filter for MPI noise can be realized at the real-time receiving end and the MPI noise can be suppressed to the maximum extent.

It should be understood that although the steps in the flowcharts involved in the above-mentioned embodiments are shown in sequence as indicated by the arrows, these steps are not necessarily executed in the order indicated by the arrows. Unless explicitly stated in this article, there is no strict order restriction on the execution of these steps, and these steps can be executed in other orders. Moreover, at least some of the steps in the flowcharts involved in the above embodiments may include multiple steps or stages. These steps or stages are not necessarily executed at the same time, but may be completed at different times. The execution order of these steps or stages is not necessarily sequential, but may be performed in turn or alternately with other steps or at least part of the steps or stages in other steps.

In one embodiment, as shown in FIG. 7, the present disclosure also provides an optical communication system, which includes:

The signal transmitting end 702 is utilized to modulate the input transmission data to generate an optical signal.

An optical fiber 704 is utilized to transmit optical signals generated by the signal transmitting end.

A signal receiving end 706 is utilized to receive the optical signal transmitted by the optical fiber, and filter the optical signal using the frequency response of the Wiener filter implemented by the above method, thereby acquiring the filtered target signal.

Specifically, as shown in FIG. 8, the signal transmitting end further includes a PAM4 encoding module and an electroabsorption modulated laser (EML). The signal receiving end further includes photodiod (PD), transimpedance amplifier (TIA), analog-to-digital converter (ADC) and digital signal processing module (DSP).

In this embodiment, its working principle is further explained in conjunction with the above-mentioned optical communication system as shown in FIG. 8. Specifically, after the binary code stream is PAM4 encoded at the transmitter, EML is utilized to intensity modulate the encoded PAM4 signal and load it on the optical carrier. The modulated optical PAM4 signal is transmitted through the optical fiber and reaches the optical receiver. The optical receiver uses PD to convert the optical signal into an electrical signal. After being amplified by TIA, it is converted into a digital signal by ADC and processed by DSP to acquire the spectrum of the received signal. Due to the existence of reflections in optical fiber links, multiple reflections via different paths are superimposed at the receiving end to form multipath interference noise MPI. Although most of the energy of the MPI noise spectrum is concentrated in the low-frequency band, the EML modulation at the transmitter will produce transient chirp, which causes the MPI noise spectrum to extend to the high-frequency band.

Therefore, at the receiving end, the MPI noise spectrum and the PAM4 signal spectrum are aliased together. Based on this, this embodiment implements the Wiener filter in the DSP at the receiving end according to the method shown in FIGS. 1 to 5. Specifically, the frequency response of the Wiener filter is determined, and spectrum analysis is performed on the frequency response of the Wiener filter. The frequency response is then decomposed to acquire the frequency response of the causal Wiener filter. Subsequently, the corresponding causal Wiener filter is obtained based on the frequency response of the causal Wiener filter. This causal Wiener filter is then used to filter the received signal to maximize the suppression of MPI noise and the noise inherent to the receiving end itself, thereby achieving optimal filtering for MPI noise.

According to the same inventive concept, embodiments of the present disclosure also provide a Wiener filter implementation device for implementing the above-mentioned Wiener filter implementation method. The solution to the problem provided by this device is similar to the solution recorded in the above method. Therefore, the specific limitations in the embodiments of the device for implementing one or more Wiener filters provided below can be found in the Wiener filter mentioned above. The limitations of the filter implementation method will not be described again here.

In one embodiment, as shown in FIG. 9, a device for implementing a Wiener filter is provided, and the device includes:
a first spectrum acquisition module 902 configured to acquire a first signal spectrum and a first power spectrum corresponding to the first test signal, wherein the first test signal is an optical signal after the signal transmitting end modulates first test data and transmits the first test data through the optical fiber;
a noise spectrum determination module 904, configured to determine a noise spectrum of the first test signal according to the first signal spectrum and the first power spectrum;
a second spectrum acquisition module 906, configured to acquire a second signal spectrum corresponding to the second test signal, wherein the second test signal is an optical signal after a signal transmitting end modulates second test data and transmits the second test data through an optical fiber, and a period of the second test data is greater than a period of the first test data; and
a filter determination module 908, configured to determine a frequency response of the Wiener filter according to the second signal spectrum and the noise spectrum of the first test signal.

In one embodiment, the filter determination module may further include: a first difference acquisition unit, configured to acquire a first difference between the second signal spectrum and the noise spectrum of the first test signal; and an acquisition unit, configured to acquire the sum between the first difference and the noise spectrum of the first test signal; a frequency response determination unit, configured to determine the Wiener filter according to the first difference and the sum frequency response.

In one embodiment, the frequency response determination unit is further configured to determine the ratio of the first difference value to the sum as the frequency response of the Wiener filter.

In one embodiment, the noise spectrum determination module is further configured to acquire a second difference between the first signal spectrum and the first power spectrum, and use the second difference as the noise spectrum of the first test signal.

In one embodiment, the device further includes: a received noise spectrum acquisition module, configured to acquire a received noise spectrum, wherein the received noise spectrum is configured to characterize the noise of the signal receiving end itself; a multipath interference noise spectrum acquisition module, configured to determine a multipath interference noise spectrum according to the noise spectrum of the first test signal and the received noise spectrum.

In one embodiment, the received noise spectrum acquisition module is specifically configured to acquire a second power spectrum corresponding to a detection signal, and use the second power spectrum as the received noise spectrum. The detection signal is the signal output by the signal receiving end when there is no optical signal input.

In one embodiment, the multipath interference noise spectrum acquisition module is specifically configured to acquire a third difference between the noise spectrum of the first test signal and the received noise spectrum, and the third difference is utilized as the multipath interference noise spectrum.

Each module in the above-mentioned Wiener filter implementation device can be implemented in whole or in part by software, hardware, and combinations thereof. Each of the above modules may be embedded in or independent of the processor of the computer device in the form of hardware, or may be stored in the memory of the computer device in the form of software, so that the processor can call and execute the operations corresponding to the above modules.

According to the same inventive concept, embodiments of the present disclosure also provide a multipath interference noise suppression device for implementing the above-mentioned multipath interference noise suppression method. The solution to the problem provided by this device is similar to the solution recorded in the above method. Therefore, for the specific limitations in the embodiments of one or more multipath interference noise suppression devices provided below, please refer to the above article on multipath interference noise. The limitations of interference noise suppression methods will not be described again here.

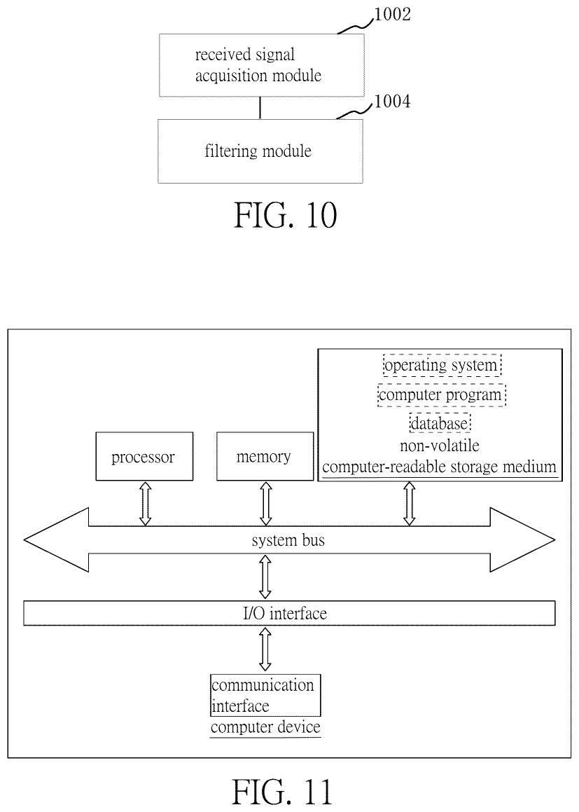

In one embodiment, as shown in FIG. 10, a device for suppressing multipath interference noise is provided. The device is applied to the receiving end of an optical communication system. The device includes:
a received signal acquisition module 1002, configured to acquire the received signal.
a filtering module 1004, configured to filter the received signal according to the frequency response of the Wiener filter to acquire a filtered target signal; wherein the frequency response of the Wiener filter is implemented according to the methods described in any one of the embodiments of FIG. 1 to FIG. 5.

In one embodiment, the filtering module is also configured to perform spectral decomposition on the frequency response of the Wiener filter to acquire the frequency response of the causal Wiener filter; and to filter the received signal according to the frequency response of the causal Wiener filter to acquire the filtered target signal.

Each module in the above multipath interference noise suppression device may be implemented in whole or in part by software, hardware, or a combination thereof. Each of the above modules may be embedded in or independent of the processor of the computer device in the form of hardware, or may be stored in the memory of the computer device in the form of software, so that the processor can call and execute the operations corresponding to the above modules.

In one embodiment, a computer device is provided. The computer device may be a server, and its internal structure diagram may be as shown in FIG. 11. The computer device includes a processor, a memory, and a network interface connected through a system bus. The processor of the computer device is configured to provide computing and control capabilities. The memory of the computer device includes non-volatile storage media and internal memory. The non-volatile storage media includes operating systems, computer programs and databases. This internal memory provides an environment for the execution of operating systems and computer programs in non-volatile storage media. The computer device's database is configured to store data such as noise spectra and filter frequency responses. The network interface of the computer device is utilized to communicate with external terminals through a network connection. When the computer program is executed by the processor, it implements a Wiener filter implementation method or a multipath interference noise suppression method.

Those skilled in the art can understand that the structure shown in FIG. 11 is only a block diagram of a partial structure related to the solution of the present disclosure, and does not constitute a limitation on the computer equipment to which the solution of the present disclosure is applied. Specific computer equipment can include more or fewer parts than shown, or combine certain parts, or have a different arrangement of parts.

In one embodiment, a computer device is provided, including a memory and a processor. The computer program is stored in the memory. When the processor executes the computer program, it implements the following steps:
acquiring a first signal spectrum and a first power spectrum corresponding to the first test signal, wherein the first test signal is an optical signal after a signal transmitting end modulates first test data and transmits the first test data through an optical fiber;
determining a noise spectrum of the first test signal according to the first signal spectrum and the first power spectrum;
acquiring a second signal spectrum corresponding to the second test signal, wherein the second test signal is an optical signal after a signal transmitting end modulates second test data and transmits the second test data through an optical fiber, and a period of the second test data is greater than a period of the first test data; and
determining a frequency response of the Wiener filter according to the second signal spectrum and the noise spectrum of the first test signal.

In one embodiment, when the processor executes the computer program, the following steps are also implemented: acquiring a first difference between the second signal spectrum and the noise spectrum of the first test signal; acquiring a sum between the first difference and the noise spectrum of the first test signal; and determining a frequency response of the Wiener filter according to the first difference and the sum.

In one embodiment, when the processor executes the computer program, the processor further implements the following step: determining a ratio of the first difference to the sum as the frequency response of the Wiener filter.

In one embodiment, when the processor executes the computer program, the processor further implements the following steps: acquiring a second difference between the first signal spectrum and the first power spectrum, and using the second difference as the noise spectrum of the first test signal.

In one embodiment, when the processor executes the computer program, the following steps are also implemented: acquiring a received noise spectrum, which is utilized to characterize a noise of a signal receiving end itself; and determining a multipath interference noise spectrum according to the noise spectrum of the first test signal and the received noise spectrum.

In one embodiment, when the processor executes the computer program, the following steps are also implemented: acquiring a second power spectrum corresponding to a detection signal, wherein the second power spectrum is utilized as the received noise spectrum, and the detection signal is a noise generated by the signal receiving end when no optical signal is input.

In one embodiment, when the processor executes the computer program, the processor further implements the following steps: acquiring a third difference between the noise spectrum of the first test signal and the received noise spectrum, wherein the third difference is utilized as the multipath interference noise spectrum.

In one embodiment, when the processor executes the computer program, it also implements the following steps: acquiring a received signal; filtering the received signal according to the frequency response of the Wiener filter to acquire a filtered target signal; and implementing the frequency response of the Wiener filter according to the method of the first aspect.

In one embodiment, when the processor executes the computer program, the following steps are also implemented: performing spectral decomposition on the frequency response of the Wiener filter to acquire the frequency response of a causal Wiener filter; and filtering the received signal according to the frequency response of the causal Wiener filter to acquire the filtered target signal.

In one embodiment, a computer-readable storage medium is provided with a computer program stored thereon. When the computer program is executed by a processor, the following steps are implemented:
acquiring a first signal spectrum and a first power spectrum corresponding to the first test signal, wherein the first test signal is an optical signal after a signal transmitting end modulates first test data and transmits the first test data through an optical fiber;
determining a noise spectrum of the first test signal according to the first signal spectrum and the first power spectrum;
acquiring a second signal spectrum corresponding to the second test signal, wherein the second test signal is an optical signal after a signal transmitting end modulates second test data and transmits the second test data through an optical fiber, and a period of the second test data is greater than a period of the first test data; and
determining a frequency response of the Wiener filter according to the second signal spectrum and the noise spectrum of the first test signal.

In one embodiment, when the computer program is executed by the processor, the following steps are also implemented: acquiring a first difference between the second signal spectrum and the noise spectrum of the first test signal; acquiring a sum between the first difference and the noise spectrum of the first test signal; and determining a frequency response of the Wiener filter according to the first difference and the sum.

In one embodiment, when executed by the processor, the computer program further implements the following step: determining a ratio of the first difference to the sum as the frequency response of the Wiener filter.

In one embodiment, when the computer program is executed by the processor, the following steps are also implemented: acquiring a second difference between the first signal spectrum and the first power spectrum, and using the second difference as the noise spectrum of the first test signal.

In one embodiment, when the computer program is executed by the processor, it also implements the following steps: acquiring a received noise spectrum, which is utilized to characterize a noise of a signal receiving end itself; and determining a multipath interference noise spectrum according to the noise spectrum of the first test signal and the received noise spectrum.

In one embodiment, when the computer program is executed by the processor, the following steps are also implemented: acquiring a second power spectrum corresponding to a detection signal, the second power spectrum is utilized as the received noise spectrum, and the detection signal is a noise generated by the signal receiving end when no optical signal is input.

In one embodiment, when the computer program is executed by the processor, the following steps are also implemented: acquiring a third difference between the noise spectrum of the first test signal and the received noise spectrum, and the third difference is utilized as the multipath interference noise spectrum.

In one embodiment, when the computer program is executed by the processor, the following steps are also implemented: acquiring a received signal; filtering the received signal according to the frequency response of the Wiener filter to acquire a filtered target signal; and implementing the frequency response of the Wiener filter according to the method of the first aspect.

In one embodiment, when the computer program is executed by the processor, the following steps are also implemented: performing spectral decomposition on the frequency response of the Wiener filter to acquire the frequency response of a causal Wiener filter; and filtering the received signal according to the frequency response of the causal Wiener filter to acquire the filtered target signal.

In one embodiment, a computer program product is provided, comprising a computer program that when executed by a processor implements the following steps:
acquiring a first signal spectrum and a first power spectrum corresponding to the first test signal, wherein the first test signal is an optical signal after a signal transmitting end modulates first test data and transmits the first test data through an optical fiber;
determining a noise spectrum of the first test signal according to the first signal spectrum and the first power spectrum;
acquiring a second signal spectrum corresponding to the second test signal, wherein the second test signal is an optical signal after a signal transmitting end modulates second test data and transmits the second test data through an optical fiber, and a period of the second test data is greater than a period of the first test data; and
determining a frequency response of the Wiener filter according to the second signal spectrum and the noise spectrum of the first test signal.

In one embodiment, when the computer program is executed by the processor, the following steps are also implemented: acquiring a first difference between the second signal spectrum and the noise spectrum of the first test signal; acquiring a sum between the first difference and the noise spectrum of the first test signal; and determining a frequency response of the Wiener filter according to the first difference and the sum.

In one embodiment, when executed by the processor, the computer program further implements the following step: determining a ratio of the first difference to the sum as the frequency response of the Wiener filter.

In one embodiment, when the computer program is executed by the processor, the following steps are also implemented: acquiring a second difference between the first signal spectrum and the first power spectrum, and using the second difference as the noise spectrum of the first test signal.

In one embodiment, when the computer program is executed by the processor, the following steps are also implemented: acquiring a received noise spectrum, which is utilized to characterize a noise of a signal receiving end itself; and determining a multipath interference noise spectrum according to the noise spectrum of the first test signal and the received noise spectrum.

In one embodiment, when the computer program is executed by the processor, the following steps are also implemented: acquiring a second power spectrum corresponding to a detection signal, wherein the second power spectrum is utilized as the received noise spectrum, and the detection signal is a noise generated by the signal receiving end when no optical signal is input.

In one embodiment, when the computer program is executed by the processor, the following steps are also implemented: acquiring a third difference between the noise spectrum of the first test signal and the received noise spectrum, and the third difference is utilized as the multipath interference noise spectrum.

In one embodiment, when the computer program is executed by the processor, the following steps are also implemented: acquiring a received signal; filtering the received signal according to the frequency response of the Wiener filter to acquire a filtered target signal; and implementing the frequency response of the Wiener filter according to the method of the first aspect.

In one embodiment, when the computer program is executed by the processor, the following steps are also implemented: performing spectral decomposition on the frequency response of the Wiener filter to acquire the frequency response of a causal Wiener filter; and filtering the received signal according to the frequency response of the causal Wiener filter to acquire the filtered target signal.

It should be noted that the user information involved in the present disclosure (including but not limited to user equipment information, User personal information, etc.) and data (including but not limited to data used for analysis, stored data, displayed data, etc.) are all information and data authorized by the user or fully authorized by all parties.

A person of ordinary skill in the art can understand that all or part of the processes in the above-mentioned embodiment method can be completed by instructing the relevant hardware through a computer program, and the computer program can be stored in a non-volatile computer-readable storage medium. When the computer program is executed, it can include the processes of the embodiments of the above-mentioned methods. Among them, any reference to the memory, database or other medium used in the embodiments provided in the present application can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. Volatile memory can include random access memory (RAM) or external cache memory, etc. As an illustration and not limitation, RAM can be in various forms, such as static random access memory (SRAM) or dynamic random access memory (DRAM). The database involved in each embodiment provided in this application may include at least one of a relational database and a non-relational database. Non-relational databases may include distributed databases based on blockchains, etc., but are not limited to this. The processor involved in each embodiment provided in this application may be a general-purpose processor, a central processing unit, a graphics processor, a digital signal processor, a programmable logic device, a data processing logic device based on quantum computing, etc., but are not limited to this.

The technical features of the above embodiments can be combined in any way. To simplify the description, not all possible combinations of the technical features in the above embodiments are described. However, as long as there is no contradiction in the combination of these technical features, all possible combinations should be used. It is considered to be within the scope of this manual.

The above-described embodiments only express several implementation modes of the present disclosure, and their descriptions are relatively specific and detailed, but should not be construed as limiting the patent scope of the present disclosure. It should be noted that, for those of ordinary skill in the art, several modifications and improvements can be made without departing from the concept of the present disclosure, and these all fall within the protection scope of the present disclosure. Therefore, the scope of protection of the present disclosure should be determined by the appended claims.

1. A method for implementing a Wiener filter, characterized in that the method includes:
acquiring a first signal spectrum and a first power spectrum corresponding to a first test signal, wherein the first test signal is an optical signal after a signal transmitting end modulates a first test data and transmits the first test data through an optical fiber;
determining a noise spectrum of the first test signal according to the first signal spectrum and the first power spectrum;
acquiring a second signal spectrum corresponding to the second test signal, wherein the second test signal is an optical signal after a signal transmitting end modulates a second test data and transmits the second test data through an optical fiber, and a period of the second test data is greater than a period of the first test data; and
determining a frequency response of the Wiener filter according to the second signal spectrum and the noise spectrum of the first test signal.

2. The method of claim 1, characterized in that determining the frequency response of the Wiener filter according to the second signal spectrum and the noise spectrum of the first test signal includes:
acquiring a first difference between the second signal spectrum and the noise spectrum of the first test signal;
acquiring a sum between the first difference and the noise spectrum of the first test signal; and
determining a frequency response of the Wiener filter according to the first difference and the sum.

3. The method of claim 2, characterized in that determining the frequency response of the Wiener filter according to the first difference and the sum includes:
determining a ratio of the first difference to the sum as the frequency response of the Wiener filter.

4. The method of claim 1, characterized in that determining the noise spectrum of the first test signal according to the first signal spectrum and the first power spectrum includes:
acquiring a second difference between the first signal spectrum and the first power spectrum, and using the second difference as the noise spectrum of the first test signal.

5. The method according to claim 1, characterized in that after determining the noise spectrum of the first test signal, the method further includes:
acquiring a received noise spectrum, which is utilized to characterize a noise of a signal receiving end itself; and
determining a multipath interference noise spectrum according to the noise spectrum of the first test signal and the received noise spectrum.

6. The method according to claim 5, characterized in that acquiring the received noise spectrum includes:
acquiring a second power spectrum corresponding to a detection signal, wherein the second power spectrum is utilized as the received noise spectrum, and the detection signal is a noise generated by the signal receiving end when no optical signal is input.

7. The method of claim 5, characterized in that determining the multipath interference noise spectrum according to the noise spectrum of the first test signal and the received noise spectrum includes:
acquiring a third difference between the noise spectrum of the first test signal and the received noise spectrum, wherein the third difference is utilized as the multipath interference noise spectrum.

8. A method for suppressing multipath interference noise,
characterized in that the method is applied to a signal receiving end of an optical communication system, and the method includes:
acquiring a received signal;
filtering the received signal according to the frequency response of the Wiener filter to acquire a filtered target signal; and
implementing the frequency response of the Wiener filter according to the method of claim 1.

9. The method according to claim 8, characterized in that the frequency response of a Wiener filter is utilized to filter the received signal to acquire the filtered target signal, including:
performing spectral decomposition on the frequency response of the Wiener filter to acquire the frequency response of a causal Wiener filter; and
filtering the received signal according to the frequency response of the causal Wiener filter to acquire the filtered target signal.

10. A device for implementing a Wiener filter, characterized in that the device includes:
a first spectrum acquisition module;
a noise spectrum determination module, configured to determine a noise spectrum of the first test signal according to the first signal spectrum and the first power spectrum;
a second spectrum acquisition module, configured to acquire a second signal spectrum corresponding to the second test signal, wherein the second test signal is an optical signal after a signal transmitting end modulates second test data and transmits the second test data through an optical fiber, and a period of the second test data is greater than a period of the first test data; and
a filter determination module, configured to determine a frequency response of the Wiener filter according to the second signal spectrum and the noise spectrum of the first test signal.

11. A device suppressing multipath interference noise, characterized in that the device is applied to a receiving end of an optical communications system, and the device includes:
a received signal acquisition module, configured to acquire a received signal; and
a filtering module, configured to filter the received signal according to the frequency response of the Wiener filter to acquire a filtered target signal; wherein the frequency response of the Wiener filter is implemented according to the method of claim 1.

12. An optical communication system, characterized in that the system includes:
a signal transmitting end, configured to modulate an input transmission data to generate an optical signal;
an optical fiber, configured to transmit the optical signal generated by the signal transmitting end; and
a signal receiving end, configured to receive the optical signal transmitted by the optical fiber, and filter the optical signal using the frequency response of the Wiener filter implemented by the method of claim 1 to acquire a filtered target signal.

13. A computer device, including a memory and a processor, wherein the memory stores a computer program, and is characterized in that the steps of the method of claim 1 are implemented when the processor executes the computer program.

14. A computer-readable storage medium on which a computer program is stored, characterized in that the steps of the method of claim 1 are implemented when the computer program is executed by a processor.

15. A computer program product, including a computer program, characterized in that the computer program implements the steps of the method of claim 1 when executed by a processor.
